(19) United States
(12) Patent Application Publication
(10) Pub. No.: US 2010/0092688 A1
(43) Pub. Date: Apr. 15, 2010

(54) SURFACE STRUCTURATION OF THEN FILMS BY LOCALIZED EJECTION OF IMMISCIBLE LIQUID

(75) Inventors: Christophe SERBUTOVIEZ, Voiron (FR); Antoine LATOUR, Grenoble (FR); Flore SONIER, Vaulnaveys Le Bas (FR)

Correspondence Address: HESLIN ROTHENBERG FARLEY & MESITI PC, 5 COLUMBIA CIRCLE, ALBANY, NY, 12203, US

(73) Assignee: COMMISSARIAT A L'ENERGIE ATOMIQUE, Paris (FR)

(21) Appl. No.: 12/547,094

(22) Filed: Aug. 25, 2009

(30) Foreign Application Priority Data
Oct. 10, 2008 (FR) 0856890

(51) Int. Cl. C08J 7/04; B05D 5/00

(52) U.S. Cl. 427/510; 427/256

(57) ABSTRACT

A method for producing topologies on the surface of an organic thin film which includes a step of localized spraying of one liquid material that is immiscible with the material constituting the thin film.

### FIELD OF THE INVENTION

The present invention relates to the structuration, that is the production of topologies, on the surface of liquid or gelated thin films. It uses microdispensing printheads to eject drops of a material that is immiscible with the material constituting the thin film.

The use of microdispensing printheads makes it possible to modify the number, position, distribution and shape of the topology thereby obtained, at will. Such topologies serve in particular to scale down the area in contact between two materials or to locally modify the optical properties of a thin film.

### PRIOR ART

Polymer materials can be structured by conventional methods of microelectronics, that is by photolithography steps. However, these methods remain costly and their compatibility with organic materials, such as polymer materials in particular, remains limited.

Moreover, the technique called “Hot Embossing” serves to create a surface topology on a material. However, this technique can only be applied to materials that withstand both the temperature and the pressure that are inherent in this method.

It should be noted that for these two methods, any change in pattern requires a change in mold or mask. Hence it is not possible to modify the patterns easily and inexpensively.

The publication of Kawase et al. (Adv. Mater. 13(21), 1601-05, 2001) also describes a method which has an application in organic electronics. It consists in dissolving a polymer using a solvent of said polymer. This solvent is ejected by an inkjet printhead or nozzle and effectively dissolves the polymer. However, a redeposition of material appears around the patterns, which is detrimental to the quality of the topologies thereby fabricated.

A final method identified is the one described in the publication by Sirringhaus et al. (Science 290(5499), 2123-26, 2000). The substrate is covered with hydrophilic or hydrophobic zones, obtained with thin films. Depending on the type of ink, it is preferably localized on the hydrophilic or hydrophobic zones. This method therefore requires the deposition of a thin film of hydrophilic or hydrophobic material on the substrate, followed by a patterning carried out by photolithography techniques. The cost of such a method is high and the film is necessarily structured throughout its depth.

### SUMMARY OF THE INVENTION

An obvious need therefore exists to develop easy and inexpensive methods for the controlled creation of patterns on the surface of thin films of a wide variety of types.

Thus, the invention relates to a method for producing topologies on the surface of an organic thin film having a liquid or gelated form, comprising a step of localized spraying of one liquid material that is immiscible with the material constituting the thin film.

The method according to the invention is based on the physical principle of phase separation also called demixing. The mixing incompatibility between the ejected liquid material, called phase II below, and the material constituting the thin film, called phase I below, is reflected by the immiscibility of the liquid in this material. Due to the physical forces associated with phase separation, this second phase (II) repels the material constituting phase I. Thus, the thin film formed by the phase I material is deformed. Note that the phase II material is not a solvent of the phase I material.

The present invention focuses on the surface structuring of thin films. This implies that the deformation which dents the thin film does not pass through it. In other words, and in a preferred embodiment whereby the thin film rests on a substrate, the thin film always has the same contact area with the substrate on completion of the inventive method.

As already stated, the thin film concerned is organic. In practice, the phase I material, that is constituting the thin film, is in liquid or advantageously gelated form. More precisely, such a material is in one of the following forms: monomers in solution, polymers in solution, liquid monomers or gel of polymers.

A thin film concerned by the invention advantageously has a thickness of 20 microns or more. This thickness corresponds to that measured on the layer in its liquid or gelated state, that is at the time of the spraying of the immiscible material. This thickness may then decrease in particular by drying or polymerization.

As mentioned above, the topologies created using the inventive method are localized on the surface of the film. More precisely, their depth does not exceed 50% of the thickness of the film and preferably remains lower than 20%.

In the case in which material I constituting the thin film is in liquid form, it advantageously has a viscosity between 200 and 5000 cps. These viscosity values are determined by the Brookfield technique well known to a person skilled in the art (T ambient, P=1 atm). A prior annealing step may be necessary to reach these values.

Alternatively and to prevent the coalescence of the sprayed material, it may be advisable to gelate the material constituting the thin film before spraying the immiscible material. This gelation is advantageously carried out by photo- or thermopolymerization. For this purpose, a polymerization initiator may be added to the material.

As to the material used to create the topologies on the surface of the thin film, it has the essential property of being immiscible with the material of the thin film. In other words, it has a mixing incompatibility with the material constituting the thin film.

Insofar as the localized spraying of this material advantageously occurs using a microdispensing printhead, even more advantageously an inkjet printhead, it is preferably a liquid ejected from the printhead in the form of drops. Thus, the spraying of the immiscible material on the surface of the thin film, advantageously in the form of drops, causes the formation of cavities.

Furthermore, and when this liquid has a lower density than the material constituting the thin film, it has been observed that the topologies were produced exclusively on the surface. This therefore constitutes a preferred embodiment insofar as such a structuration is desired. It is however possible to repeat the spraying at the same place to “excavate” the pattern.

By shifting the film and/or the spraying device, it is possible to create such topologies at various places in the thin film.

The structure and frequency of the cavities created on the surface of the thin film may therefore be selected and controlled. Thus, in particular according to the drop ejection step and the viscosity of the material constituting phase I or its crosslinkage rate, it is possible to juxtapose zones of deformation and to produce various topologies.

The immiscible liquid of phase II, present in the cavities after spraying, faces two possible developments which depend in particular on its vapor pressure in ambient conditions (standard temperature and pressure):

If it has a high vapor pressure (generally 1 mm mercury or more at Patm and Tambient), it may be evaporated, particularly during the annealing step. Simultaneously, solvents that are potentially present in the material constituting the thin film are also evaporated or the material undergoes a polymerization.

Alternatively and in particular if it has a low vapor pressure (generally 1 mm mercury or less at Patm and Tambient) and if it is polymerizable, the immiscible material may be subjected to a polymerization, advantageously a photopolymerization or a thermopolymerization in the presence of a suitable initiator. If the material constituting phase I is also thermo- or photopolymerizable, it may undergo a simultaneous polymerization. This culminates in a structure intimately combining two materials. Hence, using a simple method, it is possible to create reliefs and have them partially or totally filled using a material of interest.

Such structures allow an increase in the contact area between layers. It may, for example, be exploited for producing fuel cells and thereby structuring a film of electrolytic polymer such as Nafion® (registered trademark of Dupont de Nemours). Such a topology serves to scale down the contact area between the polymer electrolyte and a catalyst layer based on platinum/carbon. The electric power of the fuel cell is thereby increased.

Furthermore, when the real or imaginary optical indices of the materials constituting phases I and II are different, it is possible to modify the physical properties of the light transmitted or reflected by such a device

### EXEMPLARY EMBODIMENT OF THE INVENTION

The manner in which the invention can be implemented and the advantages thereof will appear more clearly from the exemplary embodiments that follow, provided for information and nonlimiting, in conjunction with the appended figures.

FIG. 1 schematically shows a cross section (A) and a plan view (B) of a thin film having cavities on its surface resulting from the inventive method.

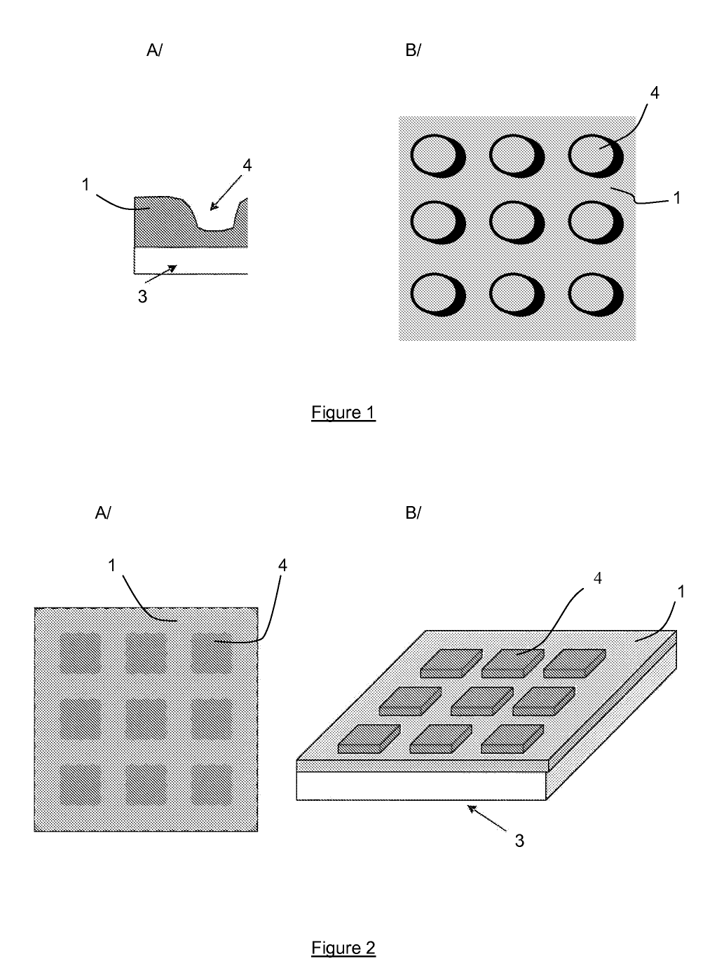

FIG. 2 shows a plan view (A) and a skewed view (B) of a surface structuring of a thin film having the form of identical slots, uniformly spaced.

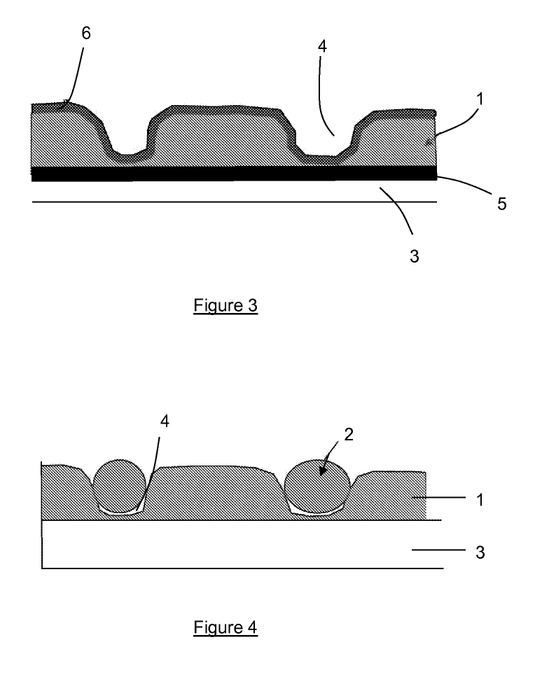

FIG. 3 shows a cross section of a fuel cell incorporating a substrate on which an anode, a layer of electrolyte polymer structured according to the invention, and a cathode, are deposited in succession.

FIG. 4 schematically shows a schematic cross section of a structure obtained using the method according to the invention in the case in which materials I and II are polymerizable.

### EXAMPLE 1

An experiment was conducted with a solution comprising the following monomers and initiator, of which the weight percentage is indicated:
2,2,3,3,4,4,4-Heptafluorobutyle acrylate (monomer): 95%;
1,1,2,2,3,3 hexafluoro 1,3 butanediol diacrylate (monomer): 4%;
Irgacure 651 (CIBA) (radical initiator): 1%

They constitute the phase I material (1).

The density of this mixture was 1.6 compared to the mixture of the following monomers and initiator, constituting the phase II material (2) and of which the weight percentage is indicated:
ethylhexyl acrylate (monomer): 90%;
nonylacrylate (monomer): 5%;
ethyleneglycol dimethacrylate (monomer): 4%;
Irgacure 651 (CIBA) (radical initiator): 1%.

The material constituting phase I (1) was deposited by coating on a flexible substrate of the polyethylene naphtalate type (Teonex® Q65 Dupont Teijin film) (3). The layer (1) was gelated by insolation in ultraviolet light at 365 nanometers for 5 seconds at an energy of 7 mW/cm². The thickness of the layer was 400 microns.

The substrate (3) was then transferred to the Altadrop inkjet machine (ALTATECH). The printer was equipped with a 60-micron Microfab printhead. 20 drops of material constituting phase II (2) were ejected by localization. After photopolymerization under UV light at 365 nanometers for 200 seconds at an energy of 7 mW/cm², a structure is observed having a juxtaposition of polymer domains issuing from the phase II material (2) in a matrix of polymers issuing from the phase I material (1), as show in FIG. 4.

### EXAMPLE 2

An experiment was conducted with a solution of 9% Cytop® fluoropolymer (Asahi Glass).

The density of this product (1) was 1.9 compared to the nematic liquid crystal 4′-Pentyl-4-biphenylcarbonitrile (2).

The Cytop material was deposited by coating on a flexible substrate (3) of the polyethylene naphtalate type (Teonex® Q65 Dupont Teijin film). The thickness of the deposit before annealing was 300 microns. The sample was annealed for 20 seconds at 40° C. The viscosity of the Cytop® solution was then 400 centipoises.

The layer (1) thus obtained was transferred to a DMP 2818 dimatix inkjet printer. 20 drops of 4′-Pentyl-4-biphenylcarbonitrile liquid crystal (2) were ejected by localisation. The assembly thus obtained was annealed at 100° C. for 120 seconds. A structure was observed having a juxtaposition of liquid crystal domains (2), independent of one another, in a fluoropolymer matrix (1), as shown in FIG. 4.

### EXAMPLE 3

An experiment was conducted with a solution of 9% Cytop® polymer (Asahi Glass).

The density of this product (1) was 1.8 compared to a mixture (2) of the following monomers and initiator, of which the weight percentage is indicated:
ethylhexyl acrylate (monomer): 85%;
nonylacrylate (monomer): 10%;
ethyleneglycol dimethacrylate (monomer): 4%;
Irgacure 651® (CIBA) (radical initiator): 1%.

The Cytop® solution was deposited by coating on a flexible substrate (3) of the polyethylene naphtalate type (Teonex® Q65 Dupont Teijin film). The thickness of the deposit before annealing was 300 microns. The sample was annealed for 20 seconds at 40° C. The viscosity of the Cytop® solution was then 400 centipoises.

The layer thus obtained (1) was transferred to a DMP 2818 Dimatix inkjet printer. The printer was equipped with a 10-picolitre printhead sold by Dimatix. 20 drops of the mixture described above (2) were ejected by localization. The assembly thus obtained was annealed at 100° C. for 120 seconds and then photopolymerized under UV light at 365 nanometers for 200 seconds at an energy of 7 mW/cm². The structure obtained is shown in FIG. 4.

### EXAMPLE 4

An experiment was conducted on a dispersion of Nafion 2010® (Dupont).

The density of the dispersion (1) was 1.2 compared to toluene (2).

This dispersion was deposited by coating on a silicon wafer (3). The thickness of the deposit before annealing was 400 microns. The substrate was annealed for 30 seconds at 50° C. The viscosity of the dispersion of Nafion® after annealing was 500 centipoises.

The substrate (3, 1) was transferred to a DMP 2818 Dimatix inkjet printer. 15 drops of toluene (2) were ejected by localization at an X-Y step of 500 microns. After annealing of the layer at 85° C. for 1 hour, a structuring of the Nafion® layer was observed in the form of slots like those shown in FIGS. 1 and 2.

The method according to the invention can be exploited for the production of fuel cells, in particular for the structuration of the electrolytic polymer layer (1), for example consisting of Nafion® (registered trademark of Dupont de Nemours). Such a topology, shown in FIG. 3, serves to scale down the contact area between the polymer electrolyte and a catalytic layer based on platinum/carbon (6). This causes an increase in the electric power of the fuel cell.

1. A method for producing topologies on the surface of an organic thin film having a liquid or gelated form and resting on a substrate, comprising a step of localized spraying of at least one liquid material that is immiscible with the material constituting the thin film.

2. A method for producing topologies on the surface of an organic thin film as claimed in claim 1, wherein the material constituting the thin film is advantageously in the following form: monomers in solution, polymers in solution, liquid monomers or gel of polymers.

3. A method for producing topologies on the surface of an organic thin film as claimed in claim 1, wherein the thin film has a thickness of 20 microns or more in its liquid or gelated state.

4. A method for producing topologies on the surface of an organic thin film as claimed in claim 1, wherein the material constituting the thin film is in liquid form, with a viscosity between 200 and 5000 cps.

5. A method for producing topologies on the surface of an organic thin film as claimed in claim 1, wherein the material constituting the thin film is in liquid form and undergoes a gelation, advantageously by photopolymerization or thermopolymerization, before the spraying step.

6. A method for producing topologies on the surface of an organic thin film as claimed in claim 1, wherein the immiscible liquid material has a lower density than the material constituting the thin film.

7. A method for producing topologies on the surface of an organic thin film as claimed in claim 1, wherein the localized spraying is carried out using a microdispensing printhead.

8. A method for producing topologies on the surface of an organic thin film as claimed in claim 1, wherein after the spraying step, the material constituting the thin film and/or the immiscible liquid material are subjected to an evaporation step.

9. A method for producing topologies on the surface of an organic thin film as claimed in claim 1, wherein after the spraying step, the materials constituting the thin film and/or the immiscible material are subjected to a polymerization step.

10. The method of claim 7 wherein the printhead comprises an inkjet printhead.
